(19) United States
(12) Patent Application Publication
(10) Pub. No.: US 2003/0098887 A1
(43) Pub. Date: May 29, 2003

(54) Graphical user interface for non-disruptively displaying messages with an indication of context

(75) Inventor: Jin Li, Toronto (CA)

Correspondence Address: David A. Mims, Jr., IBM Corporation, Intellectual Property Law Department, 11400 Burnet Road, Austin, TX, 78758, US

(73) Assignee: International Business Machines Corporation, Armonk, NY

(21) Appl. No.: 10/125,620

(22) Filed: Apr. 18, 2002

(30) Foreign Application Priority Data
Nov. 28, 2001 (CA) 2,364,007

(51) Int. Cl. G09G 5/00

(52) U.S. Cl. 345/809

(57) ABSTRACT

A graphical user interface (GUI) dynamically displays a message in a popup upon the occurrence of a triggering event. The popup comprises a callout box having a body portion in which the message is displayed and at least one indicator portion extending from the body portion to the GUI component(s) which provide(s) context for the message. At least part of the popup is located proximately to the GUI component of most recent user interaction so that the popup is noticeable by the user. The popup remains displayed while the user continues with permissible GUI interactions, such as taking steps to address the message for example. The popup is removed automatically when the message has been addressed.

### FIELD OF THE INVENTION

The present invention relates to the field of software user interfaces, and more particularly to graphical software user interfaces.

### BACKGROUND OF THE INVENTION

Error messages and informational messages are used extensively in software applications. Existing user interface designs often present error and informational messages in the form of a dialog box which “pops up” in a predetermined location of the display upon the occurrence of a triggering event. The dialog box typically includes an “OK” button which must be selected by the user in order to acknowledge the displayed message. Acknowledgement is necessary in order for the dialog box to be dismissed and for control to be restored to the application. Accordingly, this technique of message display may interrupt a user's interaction with the application and may thus be disruptive with respect to the user's ongoing work.

In another approach, the status area (or “status bar”) of a window, which is typically located at the bottom of the window, is used to display error messages or informational messages. Such status bar messages do not normally require any user acknowledgement, and in that respect they may be less invasive that the above-described dialog box messages. Nevertheless, this approach may pose a different problem in that the user may not notice the displayed message. More specifically, because the user's attention is typically focused on the graphical user interface (GUI) component (i.e. control or field) of most recent user interaction, the display of a message in a status bar that is distant from that GUI component may go unnoticed. Disadvantageously, if a user fails to notice a displayed error message, the user may be unaware of the error condition and may thus be confused as to why s/he is prevented from interacting with the application in certain respects.

Another difficulty with the status bar approach is the fact that the location of the displayed message may be distant from an area of the display which provides the context for the message. For example, upon a user's erroneous data entry near the top of a window, if an error message is displayed in a bottom-situated status bar, the distance between the status bar error message and the erroneous entry may leave the user uncertain as to which entry is erroneous.

What is therefore needed is a graphical user interface that overcomes at least some of the above noted disadvantages.

### SUMMARY OF THE INVENTION

A graphical user interface dynamically displays a message in a popup upon the occurrence of a triggering event. The popup is shaped so as to indicate to the user the area(s) of the GUI forming the context for the message. Moreover, at least part of the popup is located in the vicinity of the GUI control or field of most recent user interaction so that the popup is noticeable by the user. The popup remains displayed while the user continues with permissible GUI interactions, such as taking steps to address the message for example. The popup is removed automatically when the message has been addressed.

In accordance with an aspect of the present invention there is provided a method of displaying a message to a user in a GUI, comprising: displaying the message in a popup shaped to indicate association with at least one area of the GUI forming a context for the message, the popup being located, at least in part, proximately to a GUI control or field of most recent user interaction; allowing at least some GUI interaction to occur while the popup is displayed; and automatically dismissing the popup when the message has been addressed.

In accordance with another aspect of the present invention there is provided a method of displaying an error message to a user in a GUI, comprising: displaying the error message in a popup shaped to indicate association with at least one area of the GUI forming a context for the error message, the popup being located, at least in part, proximately to a GUI control or field of most recent user interaction; allowing at least some GUI interaction to occur while the popup is displayed; and automatically dismissing the popup when the error message has been addressed.

In accordance with still another aspect of the present invention there is provided a GUI, comprising: means for displaying a message in a popup shaped to indicate association with at least one area of the GUI forming a context for the message, the popup being located, at least in part, proximately to a GUI control or field of most recent user interaction; means for allowing at least some GUI interaction to occur while the popup is displayed; and means for automatically dismissing the popup when the message has been addressed.

In accordance with yet another aspect of the present invention there is provided a computer readable medium storing computer software that, when loaded into a computing device, adapts the device to display a message to a user in a GUI by: displaying the message in a popup shaped to indicate association with at least one area of the GUI forming a context for the message, the popup being located, at least in part, proximately to a GUI control or field of most recent user interaction; allowing at least some GUI interaction to occur while the popup is displayed; and automatically dismissing the popup when the message has been addressed.

In accordance with still another aspect of the present invention there is provided a computing device operable to display a message to a user in a GUI by: displaying the message in a popup shaped to indicate association with at least one area of the GUI forming a context for the message, the popup being located, at least in part, proximately to a GUI control or field of most recent user interaction; allowing at least some GUI interaction to occur while the popup is displayed; and automatically dismissing the popup when the message has been addressed.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In the figures which illustrate an example embodiment of this invention:

FIG. 1 is a schematic diagram of a computing system capable of displaying a graphical user interface (GUI) exemplary of the present invention;

FIG. 2A illustrates a GUI generated by the computing system of FIG. 1;

FIG. 2B illustrates the GUI of FIG. 2A displaying a popup containing an error message indicative of an error associated with one of the GUI components;

FIG. 2C illustrates the GUI of FIG. 2A displaying a popup containing another error message indicative of an error associated with two GUI components;

FIG. 3A is a Unified Modeling Language (UML) representation of a Form class implemented in the application software of FIG. 1;

FIG. 3B is a UML representation of a Popup Window class implemented in the application software of FIG. 1;

FIG. 4 illustrates a flowchart of steps executed by the computing system of FIG. 1;

FIG. 5A is a UML sequence diagram illustrating object interaction in the system of FIG. 1 during system initialization;

FIG. 5B is a UML sequence diagram illustrating object interaction in the system of FIG. 1 during the display of an error message popup;

FIG. 5C is a UML sequence diagram illustrating object interaction in the system of FIG. 1 during the update of an error message popup; and

FIG. 5D is a UML sequence diagram illustrating object interaction in the system of FIG. 1 during the dismissal of an error message popup.

### DETAILED DESCRIPTION

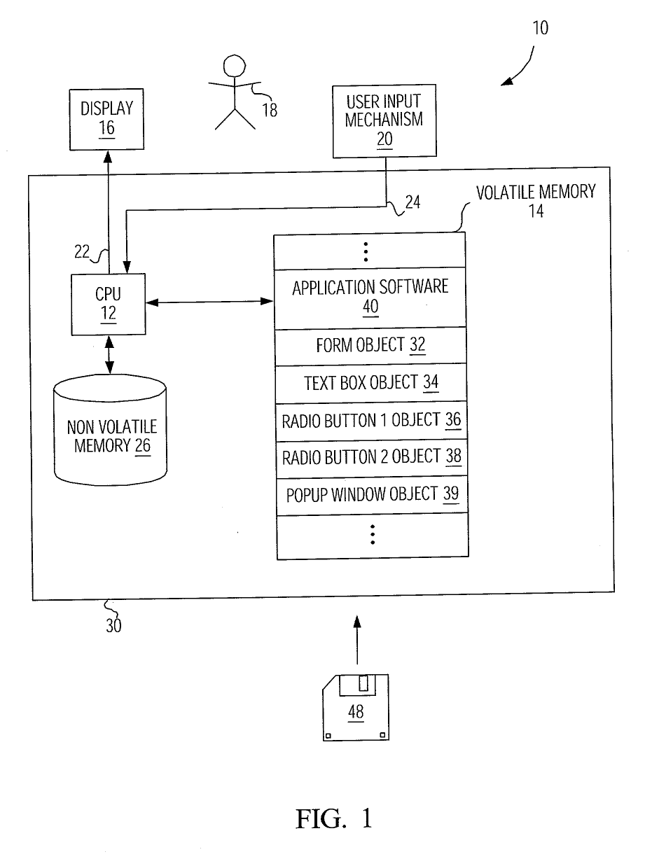

FIG. 1 illustrates an exemplary computing system 10 comprising a computing device 30 executing application software 40 stored in volatile memory 14 (e.g. RAM). The computing device 30, which may be a PC, server or handheld device for example, includes a CPU 12 in communication with the volatile memory 14 as well as non-volatile memory 26 (e.g. a hard drive). The interconnections between the volatile and non-volatile memories 14 and 26 and the CPU 12 are conventional. A display 16 for displaying a graphical user interface (GUI) to a user 18 and a user input mechanism (UIM) 20 for receiving input from the user 18 are interconnected with the CPU 12 by way of links 22 and 24 respectively. The link 22 may not be a direct connection, and may for example include a video card (not shown) in communication with both the CPU 12 (by way of a system bus) and a monitor (by way of a cable) in a conventional manner. The interconnection of the UIM 20 with the CPU 12 is also conventional and may not be direct.

Display 16 is a conventional display device, such as a CRT, flat-screen monitor or liquid crystal display, capable of presenting a GUI to a user 18. The display 16 may form part of the computing device 30 comprising the computing system 10.

The user input mechanism 20 is a device or devices capable of generating user input representative of commands for operating the application software 40. The UIM 20 may be a keyboard, touch screen, or pointing device for example, or a combination of these devices. In the present embodiment the UIM 20 comprises a keyboard and a mouse capable of controlling a movable pointer on the display 16 for interacting with a GUI. The UIM 20 may form part of the computing device 30 which comprises the computing system 10.

The application software 40 is an application comprising executable code for displaying a GUI capable of displaying popups as described herein. In the present embodiment, the application is a simple water temperature conversion application which allows a user to select one of two temperature scales (Celsius or Fahrenheit), enter a numeric value representative of a liquid water temperature in the chosen scale, and then select the other of the two temperature scales in order to convert the temperature to the other scale. In alternative embodiments, however, the application may be any other type of application of comparable or greater complexity, such as a spreadsheet or a software development tool for example.

The application software 40 (including the portion that implements the GUI) is developed using an object oriented language, such a C++ or Java™, and incorporates code from a standard UI class library, such as the Microsoft® Foundation Class library, the Java™ Foundation Class Swing components from SUN® Microsystems (“Swing”), or the Standard Widget Toolkit from IBM® for example. Various baseline classes in the included UI class library, such as a baseline dialog or “form” class, text entry box class, radio button class and window class, are subclassed (i.e. have subclasses derived therefrom) and the subclasses are adapted to implement the GUI of the present embodiment, as will be described. The application software 40 may be loaded into the volatile memory 14 of the system 10 from any suitable computer readable medium, such as a removable optical or magnetic disk 48, or from resident non-volatile memory 26 such as a hard drive or a read only memory chip.

In addition to containing the application software 40, the volatile memory 14 of FIG. 1 contains a Form object 32, a Text Entry Box object 34, Radio Button 1 object 36, Radio Button 2 object 38, and Popup Window object 39. These five objects 32, 34, 36, 38 and 39 comprise instantiations of the adapted subclasses referred to above and cumulatively implement the GUI of the present embodiment. It will be appreciated that the objects 32, 34, 36, 38 and 39 only exist in volatile memory 14 at run time.

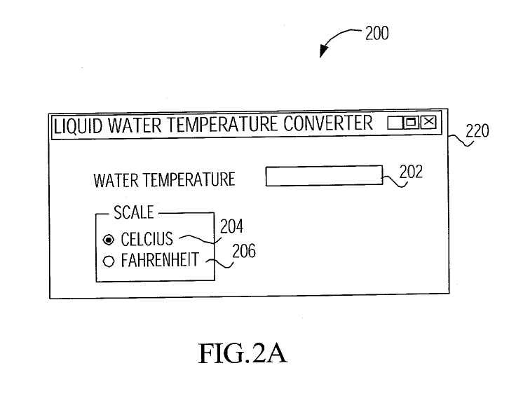

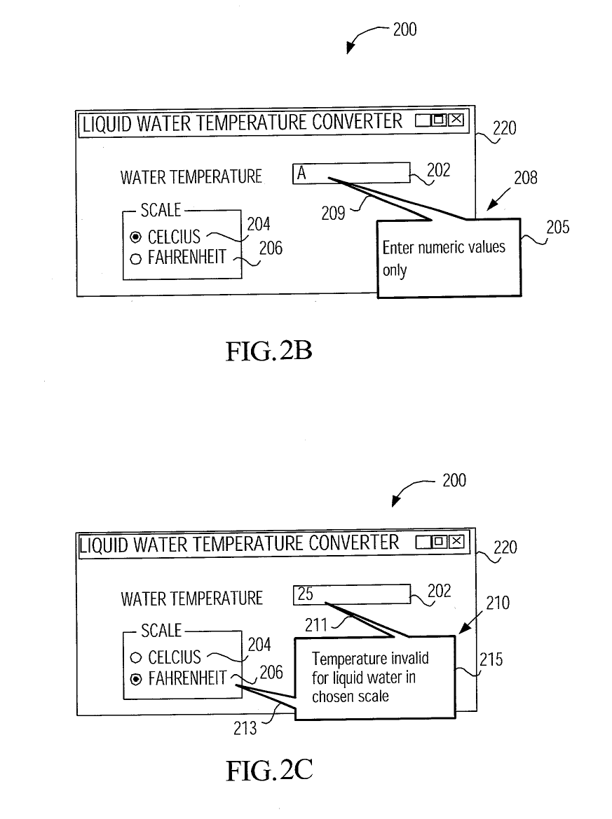

FIGS. 2A, 2B and 2C illustrate a GUI 200 generated by the computing system 10 when the application software 40 is executed. The GUI 200 comprises a form 220 containing various GUI component comprising a text entry box 202 for entering a numeric water temperature value and a pair of radio buttons 204 and 206 for selecting one of the two temperature scales (Celsius or Fahrenheit). The GUI 200 of FIG. 2A is illustrated in its default state prior to the entry of any data by the user 18.

FIG. 2B illustrates the GUI 200 displaying a popup 208 containing a textual error message “Enter numeric values only”. Popup 208 is displayed by the computing system 10 when the entry of at least one non-numeric character into text entry box 202 is detected, in order to indicate to the user 18 that only numeric values should be entered in text entry box 202. In the present embodiment, popup 208 is in the form of a callout box which, as is known to those skilled in the art, comprises a two-dimensional body portion capable of displaying text and at least one indicator portion extending from the body portion towards a display area. Popup 208 thus includes a body portion 205 containing the textual error message and an indicator portion 209 (comprising an arrow in the present case). The indicator portion 209 provides context for the error message by pointing to the GUI control or field in which the erroneous entry was made (i.e. text entry box 202). Popup 208 remains displayed until the erroneous entry of one or more non-numeric characters into text entry box 202 has been corrected by the user 18.

FIG. 2C illustrates the GUI 200 displaying a different popup 210 containing the textual error message “Temperature invalid for liquid water in chosen scale”. The popup 210 is displayed when the combination of the numeric value entered in text entry box 202 and the selected temperature scale (as indicated by the selected radio button 204 or 206) is erroneous in the context of the present application. In FIG. 2C, for example, the combination of the entered numeric temperature “25” and the selected Fahrenheit scale are erroneous because they indicate a below-freezing value for liquid water (assuming no super-cooling of water is possible). Like the popup 208, popup 210 also comprises a callout box and includes a body portion 215 containing the relevant textual error message. However, popup 210 has two context-providing indicator portions 211 and 213 instead of only one indicator portion 209. The indicator portions 211 and 213 point to text entry box 202 and radio button 206 (respectively) to indicate that the value of this GUI field and the setting of this GUI control have caused the present error.

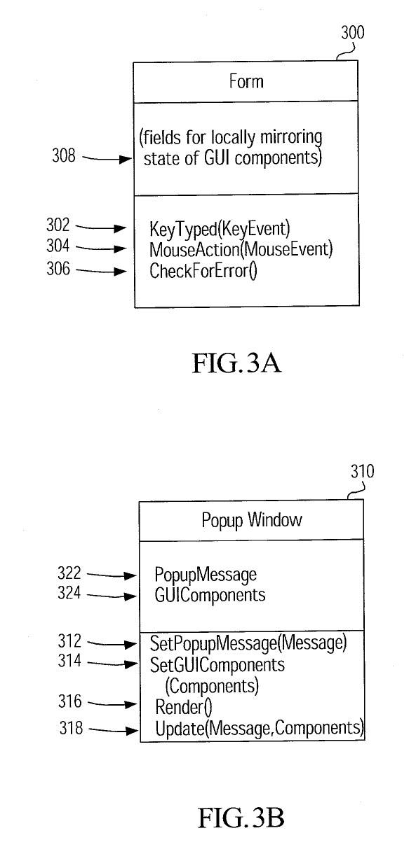

Referring now to FIGS. 3A and 3B, two classes comprising application software 40, namely a Form class 300 and a Popup Window class 310, are illustrated in Unified Modeling Language (UML) notation. The notation of FIGS. 3A and 3B follows the standard nomenclature for UML as set out in, for example, Grady Booch, Ivar Jacobsen, James Rumbaugh, “The Unified Modeling Language User Guide”, Addison-Wesley, 1999, the contents of which are incorporated herein by reference.

The Form class 300 of FIG. 3A defines the content and behavior of the form 220 of GUI 200. When instantiated at run time, Form class 300 comprises the Form object 32 in volatile memory 14 (FIG. 1). Form class 300 is subclassed from a standard UI library “form” class (e.g. JPanel in Java™) and thus inherits various fields and methods (not illustrated) pertaining to a form object. The form class 300 is implemented as a “listener” object that is capable of being registered with various GUI fields or controls (such as the Text Entry Box object 34 and Radio Button 1 and 2 objects 36 and 38) at run time. This registration will permit the Form object 32 to dynamically receive notifications of the occurrence of certain system events, such as keyboard events or mouse actions, at the GUI field 202 and controls 204 and 206 (FIG. 2A). Form class 300 includes a set of fields 308 which is used to locally mirror the state of the GUI control objects 34, 36 and 38 for reference during the processing of system events (as will later be described). Moreover, class 300 includes three methods, namely a KeyTyped( ) method 302, MouseAction( ) method 304, and CheckForErrors( ) method 306, which implement (in part) the message display capability of the present embodiment. Other methods may be included in Form class 300 despite not being illustrated in FIG. 3A.

The KeyTyped( ) method 302 is automatically invoked every time the Form object 32 receives notification of a keyboard event occurring in the text entry box 202. This automatic invocation occurs as a result of the registration of the Form object 32 as a listener object with Text Entry Box object 34. The method 302 has a single input parameter “KeyEvent” representative of the detected keyboard event. Execution of this method triggers the execution of the CheckForErrors( ) method 306 and other processing, as will be described.

The MouseAction( ) method 304 is automatically invoked every time that the Form object 32 receives notification of a mouse action (e.g. a mouse click) in either of the radio buttons 204 or 206 at run time. This automatic invocation occurs as a result of the registration of Form object 32 as a listener object with respect to both the Radio Button 1 object 36 and the Radio Button 2 object 38 (FIG. 1). The method 304 has a single input parameter “MouseEvent” representative of the detected mouse action. As with the KeyTyped( ) method 302, execution of the MouseAction( ) method 304 triggers the execution of the CheckForErrors( ) method 306 and other processing, as described below.

The CheckForErrors( ) method 306 is responsible for determining whether, based on the current state of the Form class fields 308 (which mirror the current state of the GUI field 202 and controls 204 and 206), an error condition exists in the application. In the present embodiment, there are two possible error conditions: (1) the existence of one or more non-numeric characters in the text entry box 202, and (2) the presence of an erroneous combination of liquid water temperature in text entry box 202 and selected temperature scale (as reflected by the state of radio buttons 204 and 206). It will be appreciated that other applications may comprise different error conditions which may number less than or more than two.

The Form class 300 also includes code (comprising various other methods for example) which, when executed, is capable of causing a popup 208 or 210 to be displayed, updated or dismissed, depending upon the error condition (if any) determined to be in existence and the current system state. The processing performed by these methods will be described in more detail below in the description of the operation of the computing system 10.

FIG. 3B illustrates the Popup Window class 310 which defines the content and behavior of a popup 208 or 210 (FIG. 2B or 2C). When instantiated at run time, class 310 comprises the Popup Window object 39 (FIG. 1). Popup Window class 310 is subclassed from a standard UI library window class (e.g. JWindow in Java™) and thus inherits various fields and methods pertaining to a window object. For example, Popup Window class 310 includes an inherited Show( ) method which triggers display of the rendered popup and an inherited Hide( ) method which causes a displayed popup to be dismissed (neither of these methods are illustrated).

In the present embodiment, the Popup Window class 310 is adapted to cause the associated popup 208 or 210 to be implemented as a modeless window which, as known by those skilled in the art, is capable of being continuously displayed while the user 18 shifts the focus of the computing device 30 to other applications or processes and interacts with them. At run time, this will permit the popup to be continuously displayed on the display 16 while the user 18 interacts with the fields/controls of the GUI 200, for example to address any problem identified by the message (with this interaction possibly being limited depending upon the operative error condition).

As may be seen in FIG. 3B, the Popup Window class 310 includes a PopupMessage field 322 and a GUIComponents field 324. The PopupMessage field 322 is a string comprising the message that is either presently being displayed or has most recently been displayed in popup 208 or 210. The GUIComponents field 324 identifies the GUI field(s) and/or control(s) providing the context for the current or most recently displayed message. Thus for example, assuming that a popup 210 is displayed as in FIG. 2C, the value of field 322 of the corresponding popup window object would be “Temperature invalid for liquid water in chosen scale”, and the value of field 324 would identify Text Entry Box object 34 and Radio Button 2 object 38 as the objects associated with the GUI components which have caused the error to arise (i.e. GUI field 202 and GUI control 206).

The Popup Window class 310 includes public “setter” methods SetPopupMessage( ) 312 and SetGUIComponents( ) 314 by which the above-noted fields 322 and 324 (respectively) may be set. Additionally, popup Window class 310 includes a Render( ) method 316 which permits the associated popup 208 or 210 to be rendered in the form of a callout text entry box, having one or more arrows pointing to one or more desired display location(s). The Popup Window object 39 also includes an Update( ) method 318 which takes a “Message” input parameter comprising a desired popup message and a “Components” input parameter identifying the object(s) associated with the GUI field(s)/control(s) providing the context for the message. The Update( ) method 318 updates the location, shape and textual content of an already-created popup as necessary based on the received parameters and the current popup location, shape and content to ensure that the popup accurately reflects the operative error condition. The Update( ) method 318 invokes the SetPopupMessage( ) method 312, SetGUIComponents( ) method 314, Render( ) method 316 and inherited Show( ) method.

Other fields and methods may be included in Popup Window class 310 despite not being illustrated in FIG. 3B.

Application software 40 further includes a text entry box class (not illustrated) which defines the appearance and behavior of text entry box 202 and which, when instantiated at run time, comprises the Text Entry Box object 34 (FIG. 1). Moreover, the application software 40 also includes two radio button classes (not illustrated) which define the appearance and behavior of radio buttons 204 and 206 respectively. When instantiated at run time, these two classes comprise Radio Button 1 object 36 and Radio Button 2 object 38 respectively. In the present embodiment, the text entry box class and the radio button classes are contained by the form class 300 (i.e. the Form class 300 is the “parent” class and comprises the “children” GUI component classes). Application software 40 also includes a timer class (not illustrated) which is used to delay the display of popup 208 or 210 until slightly after the detection of an error condition, for reasons which will be set forth below. The behavior of these various classes (or more precisely, of the objects instantiated from these classes) will become apparent in the following description of the system's operation.

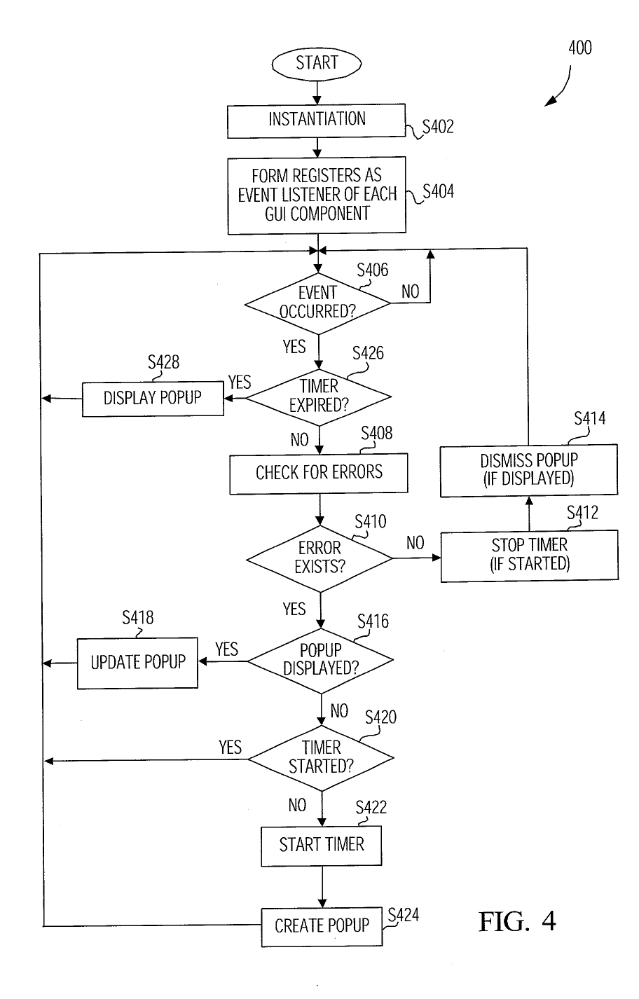

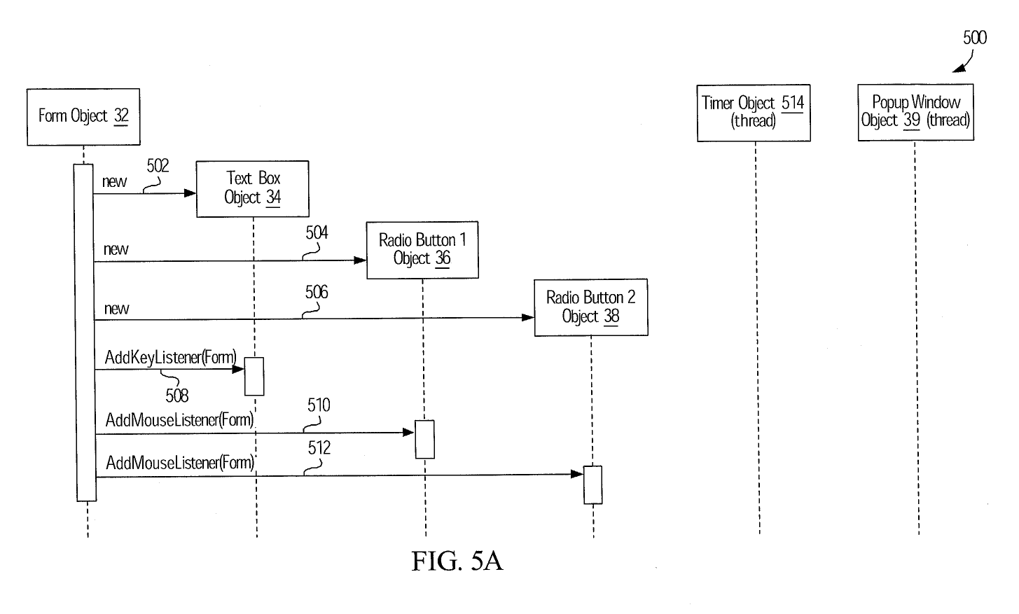

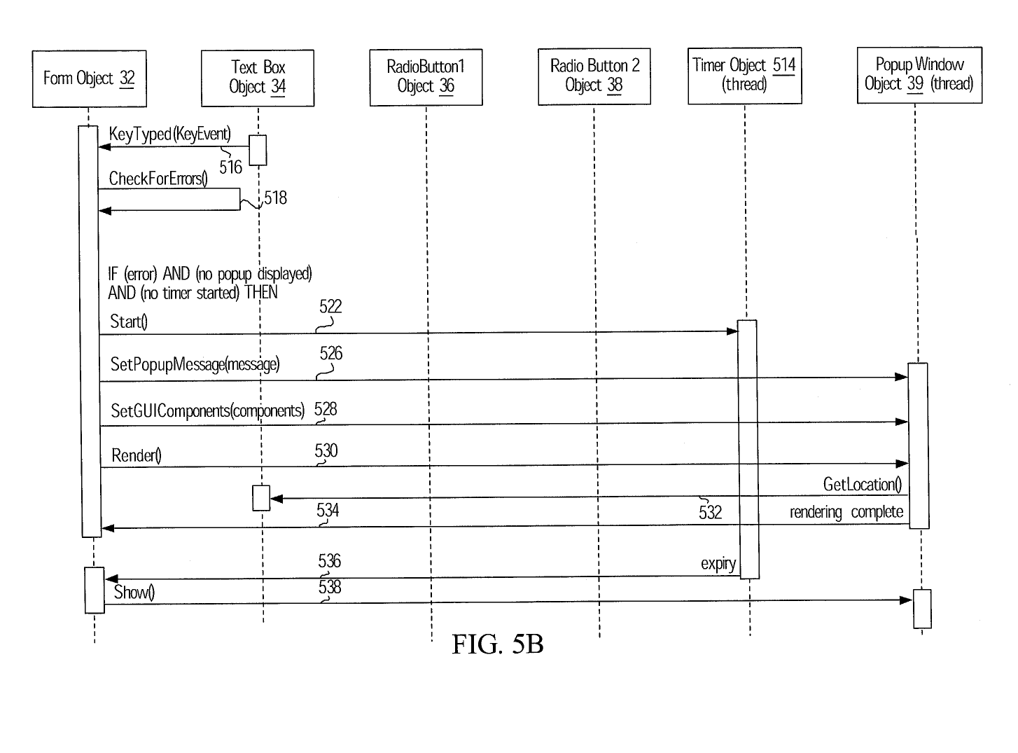

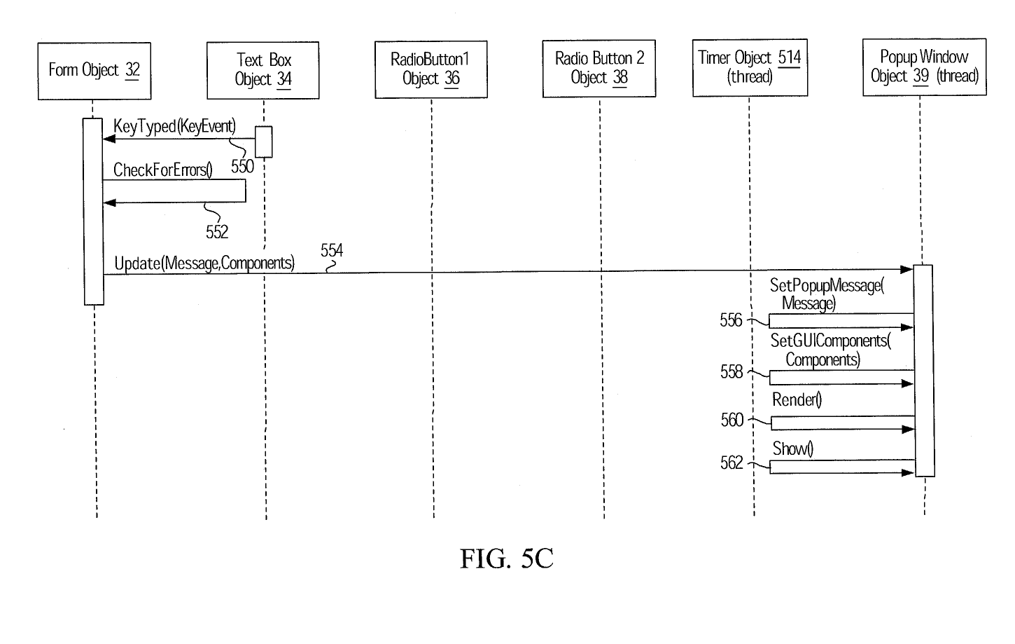

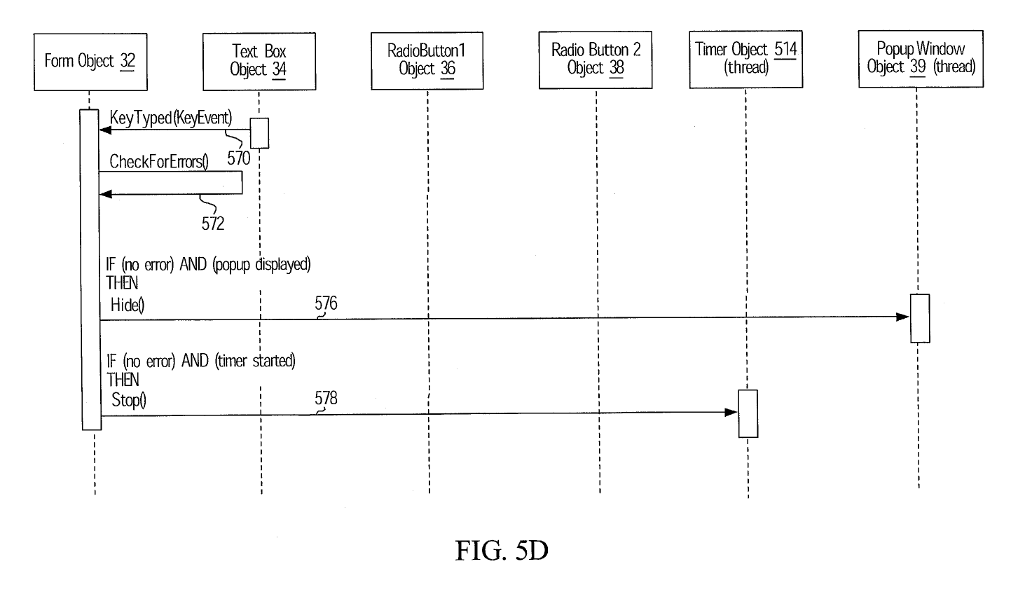

The operation of the present embodiment is illustrated in the flowchart of steps 400 of FIG. 4 and in UML sequence diagrams 5A through 5D. The flowchart 400 illustrates the system's event-handling loop which, depending on the current system state and the user's manipulations of the various GUI components, may result in a popup 208 or 210 being displayed, updated or dismissed. It will be appreciated that the events handled by the illustrated event loop are events for which the Form Object 32 will register itself as a listener (i.e. events of interest in the present embodiment for determining whether an error condition has arisen), as well as timer expiry events. The UML sequence diagrams of FIGS. 5A to 5D, on the other hand, each illustrate system object interaction during a particular stage of operation. More specifically, FIGS. 5A to 5D correspond to a system initialization stage, a popup display stage, a popup update stage and a popup dismissal stage respectively. Each of these stages corresponds to a different path through the flowchart 400. The stages will be described in turn.

The system initialization stage is illustrated in the UML sequence diagram FIG. 5A and spans steps S402 and S404 of the flowchart 400. This stage is executed once per invocation of application software 40. In step S402, various objects comprising Form object 32, Text Entry Box object 34, Radio Button 1 object 36, and Radio Button 2 object 38 are instantiated in volatile memory 14 (FIG. 1). These instantiations occur at calls 502, 504 and 506 of FIG. 5A, in which the instantiated Form object 32 triggers the instantiation of the above-listed GUI component objects (reflecting the implementation of the present embodiment in which the Form object 32 is the “parent” of the various “children” GUI component objects). Also instantiated during this stage are Timer object 514 and Popup Window object 39. Each of the latter two objects is instantiated in a separate thread.

The instantiations of Form object 32, Text Entry Box object 34, Radio Button 1 object 36, and Radio Button 2 object 38 result in the display of the GUI 200 in its default state (as shown in FIG. 2A) on the display 16 (FIG. 1). The fields 308 of Form object 32, which are used to locally maintain the state of the GUI components 202, 204 and 206 of form 220, are initialized at this time to reflect the initial state of these GUI components.

In the subsequent step S404, Form object 32 registers itself as an event listener for the Text Entry Box object 34 and Radio Button 1 and 2 objects 36 and 38. More specifically, Form object 32 invokes (at call 508 of FIG. 5A) an AddKeyListener( ) method of Text Entry Box object 34, to ensure that the Form object 32 will be notified of every keyboard event occurring at text entry box 202. Moreover, Form object 32 also invokes (at calls 510 and 512) an AddMouseListener( ) method of each of Radio Button 1 object 36 and Radio Button 2 object 38, to ensure that the Form object 32 will be notified of every mouse action event occurring at either of radio buttons 204 and 206. The latter registration concludes the system initialization stage.

The popup display stage is illustrated in the UML sequence diagram of FIG. 5B. This stage may be executed multiple times during the execution of application software 40. The popup display stage comprises two phases: a setup phase and a display phase. In the setup phase, the system error condition is detected and, in response, the creation of a popup (popup 208 in this case) and a timer countdown are initiated in parallel. In the subsequent popup display phase, the timer expires and the created popup 208 is thereafter displayed.

Beginning with the setup phase, initially the user 18 utilizes UIM 20 to enter a single character “A” into text entry box 202, as illustrated in FIG. 2B. A keyboard event corresponding to this data entry is detected in step S406. In particular, Form object 32 is notified of this event through the automatic invocation 516 (FIG. 5B) of the KeyTyped( ) method 302 (FIG. 3A). Upon being invoked, the KeyTyped( ) method 302 updates the fields 308 of Form object 32 to reflect the new text entry box state (to indicate that the text entry box 202 now contains a single character “A”) based on the information contained in the received KeyEvent parameter. Subsequently, it is confirmed in step S426 that the most recently detected event is not a timer expiry (as no timer has yet been started). Accordingly, the KeyTyped( ) method 302 next invokes (at call 518 of FIG. 5B) the CheckForErrors( ) method 304 in step S408.

Upon being invoked, the CheckForErrors( ) method 304 examines the current state of the local fields 308 of Form object 32 to determine whether an error condition has arisen. In the present case, this examination reveals (at step S410) that an error condition has in fact arisen, in that a non-numeric character has been entered into the text entry box 202.

Accordingly, in steps S416 and S420, the Form object 32 examines whether a popup is presently displayed and whether a timer countdown has been started (respectively). In the present case, these examinations reveal that no popup has been created and that no timer countdown has been started. Cumulatively, these findings indicate that the creation of a popup to alert the user 18 to the newly-detected error condition is warranted. Accordingly, in step S422 a timer countdown is triggered by way of the invocation 522 of the Start( ) method of the Timer object 514 (FIG. 5B). It will be recognized that, because the Timer object 514 is executed in a separate thread from the Form object 32, processing within the Form object 32 may continue in parallel with the timer's countdown.

It will be appreciated that a timer is included in the present embodiment to introduce a short delay between the detection of an error condition and the display of the corresponding error message popup. This delay reduces the abruptness of the feedback presented to the user 18. The delay is desirable in the present embodiment in view of the fact that the user 18 may quickly notice and correct his/her errors without any prompting from the system 10, in which case the immediate display of a popup is not only unnecessary but may be bothersome. Accordingly, a desirable timeout period may be in the range of 1 to 2 seconds.

Subsequently, in step S424 the creation of a popup 208 (FIG. 2B) is initiated. Step S424 entails three distinct steps, which are visible in FIG. 5B. In a first step, the Form object 32 invokes (at call 526) the SetPopupMessage( ) method 312 of Popup Window object 39, passing the desired error message (“Enter numeric values only”) thereinto. In a second step, the Form object 32 invokes (at call 528) the SetGUIComponents( ) method 314 of Popup Window object 39, passing the identity of the object(s) associated with the GUI component(s) providing the context for the message (which in the present case comprises the identity of Text Entry Box object 34). The first and second steps provide the Popup Window object 39 with the information that it requires in order to determine how popup 208 should be rendered (i.e. its location and shape). Finally, in a third step the Form object 32 invokes (at call 530) the Render( ) method 316 of the Popup Window object 39, in order to trigger the rendering of the popup 208 in volatile memory 14.

Following the invocation of the Render( ) method 316, it will be appreciated that, because the Popup Window object 39 is in a separate thread from Form Object 32, the user is free to interact with the form 220 during the rendering of the popup if this is desired.

After step S424 has been executed, control returns to step S406, where the system waits for the next event.

In the meantime, popup creation processing continues in Popup Window object 39, in parallel with any processing occurring in Form object 32 as well as the timer's countdown. In particular, after being invoked in step S424 the Render( ) method 316 of the Popup Window object 39 in turn invokes (at call 532 of FIG. 5B) a GetLocation( ) method of the object associated with the GUI components(s) in which the error originated (i.e. Text Entry Box object 34 in the present case). The purpose of this call 532 is to determine the location of the offending GUI component, text entry box 202. The returned location information is then utilized by the Render( ) method 316 in its determination of the callout box's location and shape. More specifically, the popup 208 is created in volatile memory with a location that is near the GUI field 202 which has just recently been interacted with by the user 18 (so that the popup 208 is noticeable by the user 18) and an indicator portion 209 having a tip that is located in or near text entry box 202 (so as to provide the user 18 with context information for the displayed message).

Once the rendering has been completed, Form object 32 is notified of this fact via notification 534. This notification, which is implemented using the standard multi-thread notification system known to those skilled in the art, completes the setup phase of the popup display stage.

Assuming that no intervening system events occur, the next system event detected in step S406 is the expiry of the timer. The Form object 32 is notified of the timer's expiry via notification 536 (FIG. 5B). This notification, which is also implemented using the standard multi-thread notification system, signals the commencement of the display phase of the present stage of operation.

In step S426, it is confirmed that the most recently detected event in step S406 was in fact the expiry of Timer object 514. As a result, the popup is displayed in step S428. This is achieved through the invocation 538 of the Show( ) method of the Popup Window object 39. The display phase, as well as the popup display stage as a whole, are thus concluded.

It will be appreciated that, because the popup 208 is displayed proximately to the GUI field on the display 16 into which the user 18 was only moments ago entering a character, the displayed message is, advantageously, noticeable by the user 18. Moreover, the positioning of the tip of the indicator portion 209 in or near the same GUI field provides an indication of context for the displayed message.

The popup update stage is illustrated in the UML sequence diagram of FIG. 5C. This stage of operation occurs when a keyboard or mouse event is detected and a popup is already being displayed. Its purpose is to ensure that the message contained in the popup, as well as the popup's location and shape, are commensurate with the current error condition, which may have changed as a result of the newly detected event. The popup update state may be executed multiple times during the execution of application software 40.

Initially, the user 18 utilizes the UIM 20 to enter a second character “B” into text entry box 202. Form object 32 is notified of this event through the automatic invocation 550 (FIG. 5C) of the KeyTyped( ) method 302 (FIG. 3A). Upon being invoked, the KeyTyped( ) method 302 again updates the fields 308 of Form object 32 to reflect the new text entry box state (to reflect the fact that the text entry box 202 now contains the two characters “AB”) based on information contained in the received KeyEvent parameter. Subsequently, it is confirmed in step S426 that the most recently detected event is not a timer expiry. As a result, the KeyTyped( ) method 302 invokes (at call 552 of FIG. 5B) the CheckForErrors( ) method 304 at step S408.

Upon being invoked, the CheckForErrors( ) method 304 examines the current state of the fields 308 of Form object 32 to determine whether an error condition still exists in view of the most recently detected event, and if so, which error condition is operative. In the present case, this examination reveals (at step S410) that the same error condition still exists, in that at least one non-numeric character is present in the text entry box 202. Next, in step S416 the Form object 32 examines whether a popup has previously been displayed. This examination reveals that a popup (in particular, popup 208) is in fact presently displayed. As a result, in step S418, the popup 208 is updated. More specifically, the Update( ) method 318 of the Popup Window object 39 is invoked (at call 554 of FIG. 5C). Two parameters are passed to the Update method: an error message (“Enter numeric values only”) and the identity of the object(s) associated with the GUI component(s) in which the error message was made (Text Entry Box object 34).

Upon being invoked, the Update( ) method 318 utilizes the received parameters to update the popup's message, location and shape and then redisplays the popup. This is accomplished in four distinct steps, which are visible in FIG. 5C. In a first step, the Popup Window object 39 invokes (at call 556) the SetPopupMessage( ) method 312 of Popup Window object 39, passing the error message received from the Form Object 32 thereinto. In a second step, the Popup Window object 39 invokes (at call 558) the SetGUIComponents( ) method 314 of Popup Window object 39, passing the GUI component identity received from Form Object 32. In a third step the Popup Window object 39 invokes (at call 560) the Render( ) method 316 of the Popup Window object 39, in order to trigger the rendering of the popup 208 in volatile memory 14. Finally, in a fourth step the Popup Window object 39 invokes the Show( ) method in order to display the updated popup 208 on the display 16. The popup update stage is thus concluded.

It will be appreciated that, in the present case, the execution of the Update( ) method 318 does not result in any change to popup 208 in view of the fact that the currently operative error condition is the same as the initial error condition.

It will further be appreciated that the caller of the Update( ) method 318 (i.e. Form Object 32) in the present embodiment is blocked until the rendering and display of the popup is complete.

The popup dismissal stage is illustrated in the UML sequence diagram of FIG. 5D. This stage of operation causes a displayed popup to be dismissed (i.e. made to disappear from the display 16) when the associated error condition ceases to exist. The popup dismissal stage may occur multiple times during the execution of application software 40.

Assuming that the current state of the system 10 is again as shown in FIG. 2B, the user 18 presses a delete key of the keyboard comprising UIM 20 to remove the character “A” from text entry box 202. Form object 32 is notified of this keyboard event through the automatic invocation 570 (FIG. 5D) of the KeyTyped( ) method 302 (FIG. 3A). Upon being invoked, the KeyTyped( ) method 302 updates the fields 308 of Form object 32 to reflect the new text entry box state (to reflect the fact that the text entry box 202 is now empty) based on information regarding the pressed key that is contained in the received KeyEvent parameter. Subsequently, it is confirmed in step S426 that the most recently detected event is not a timer expiry. As a result, the KeyTyped( ) method 302 invokes (at call 572 of FIG. 5B) the CheckForErrors( ) method 304 at step S408.

Upon being invoked, the CheckForErrors( ) method 304 examines the current state of the fields 308 of Form object 32 to determine whether an error condition still exists in view of the most recently detected event. In the present case, this examination reveals (at step S410) that the previous error condition has in fact ceased to exist in that no non-numeric characters are present in the text entry box 202. As a result, in subsequent step S412, it is determined that the timer is not presently started and that no stopping of the timer is therefore required (in the event that the timer had been discovered to be actively counting down in step S412, the timer would have been stopped through an invocation 578 of the Stop( ) method of Timer object 514, as shown in F5C). Then, in step S414, it is determined that the popup is presently displayed and that the popup should therefore be dismissed. Dismissal is achieved through an invocation 576 (FIG. 5D) of the Hide( ) method of Popup Window object 39, which causes the popup 208 to disappear from the display 16. The popup dismissal stage is thus concluded.

It will be appreciated that, because the dismissal of the popup 208 has occurred automatically upon the user's correction of the associated error condition with no explicit acknowledgement of the popup 208 by the user 18 being required, the disruption caused by the message display is, advantageously, minimized.

System operation continues until the user exits the event-handling loop of flowchart 400 by terminating the application through conventional methods.

As will be appreciated by those skilled in the art, modifications to the above-described embodiment can be made without departing from the essence of the invention. For example, popups need not necessarily be rendered in the form of a traditional callout comprising a rectangular “text box” with arrows emanating therefrom. Rather, the body of a popup may have any non-rectangular two dimensional shape, or may simply comprise free-floating text. As well, lines or other indicators may be used rather than arrows to point to GUI component(s) which provide context for the displayed message.

The granularity of the “system events” which drive the event-handling loop of FIG. 4 may be larger than that of the described embodiment. For example, rather than responding to each keystroke, the system 10 could be made to respond to the entry of only the “Enter” key. Thus, entire words or phrases could be typed by the user 18 and buffered by the computing system 10 without triggering popup message processing. Such an approach may be suitable for applications in which error conditions are evaluated on a word-by-word basis (e.g. spell-checking applications).

The use of a timer to introduce a short delay between the detection of an error condition and the display of an associated popup is also not required. For example, in some applications it may be desirable to notify the user 18 of an error condition immediately upon its detection. This may be desirable in cases where quick correction of the error is important, for example. Moreover, use of a timer may be unnecessary in cases where the rendering of a popup takes longer to complete than the desired delay interval. In this case, the popup may be displayed immediately upon the completion of popup rendering. A possible disadvantage of this approach however is the fact that run-time behavior may be less deterministic in terms of the length of the delay between the occurrence of an error and the subsequent display of an error message popup.

Also, it is not necessary for the Popup Window object 39 to be implemented in a separate thread from the Form Object 32. While the use of separate threads for these objects does tend to improve system performance, e.g. by permitting the user to continue to interact with the form 220 while a popup 208 is being rendered, the system 10 would be operable without the use of separate threads.

It is not required that the entirety of a popup be located proximately to the GUI control or field of most recent user interaction. It is only necessary for the popup to be noticeable by the user 18. Thus it may be sufficient for just part of the popup to be located proximately to the GUI control or field of most recent user interaction.

It is not necessary for Form class 300 to maintain local fields which mirror the current state of the various GUI components 202, 204 and 206. In alternative embodiments, the CheckForErrors( ) method 304 may dynamically query the objects associated with these GUI components to determine their status.

Finally, though the present embodiment illustrates the use of popups to display error messages, the same approach may be used to display any other type of message, such as an informational message for example. In the latter case, it will be appreciated that the CheckForErrors( ) method 304 does not check for error conditions per se, but rather simply checks for conditions warranting the display of a message.

Other modifications will be apparent to those skilled in the art and, therefore, the invention is defined in the claims.

What is claimed is:

1. A method of displaying a message to a user in a graphical user interface (GUI), comprising:
displaying said message in a popup shaped to indicate association with at least one area of the GUI forming a context for said message, said popup being located, at least in part, proximately to a GUI control or field of most recent user interaction;
allowing at least some GUI interaction to occur while said popup is displayed; and
automatically dismissing said popup when said message has been addressed.

2. The method of claim 1 wherein said shape of said popup comprises a two-dimensional body portion with at least one indicator portion extending from said body portion towards said at least one GUI area.

3. The method of claim 2 wherein a 1-to-1 correlation exists between said at least one indicator portion and said at least one GUI area.

4. The method of claim 2 wherein said at least one indicator portion comprises an arrow.

5. The method of any of claims 1 to 4 wherein said popup comprises a modeless window.

6. A method of displaying an error message to a user in a GUI, comprising:
displaying said error message in a popup shaped to indicate association with at least one area of the GUI forming a context for said error message, said popup being located, at least in part, proximately to a GUI control or field of most recent user interaction;
allowing at least some GUI interaction to occur while said popup is displayed; and
automatically dismissing said popup when said error message has been addressed.

7. The method of claim 6 wherein said shape of said popup comprises a two-dimensional body portion with at least one indicator portion extending from said body portion towards said at least one GUI area.

8. The method of claim 7 wherein a 1-to-1 correlation exists between said at least one indicator portion and said at least one GUI area.

9. The method of claim 7 wherein said at least one indicator portion comprises an arrow.

10. The method of any of claims 6 to 9 wherein said popup comprises a modeless window.

11. A GUI, comprising:
means for displaying a message in a popup shaped to indicate association with at least one area of the GUI forming a context for said message, said popup being located, at least in part, proximately to a GUI control or field of most recent user interaction;
means for allowing at least some GUI interaction to occur while said popup is displayed; and
means for automatically dismissing said popup when said message has been addressed.

12. The GUI of claim 11 wherein said shape of said popup comprises a two-dimensional body portion with at least one indicator portion extending from said body portion towards said at least one GUI area.

13. The GUI of claim 12 wherein a 1-to-1 correlation exists between said at least one indicator portion and said at least one GUI area.

14. The GUI of claim 12 wherein said at least one indicator portion comprises an arrow.

15. The GUI of any of claims 11 to 14 wherein said popup comprises a modeless window.

16. The GUI of any of claims 11 to 15 wherein said message is an error message.

17. A computer readable medium storing computer software that, when loaded into a computing device, adapts said device to display a message to a user in a GUI by:
displaying said message in a popup shaped to indicate association with at least one area of the GUI forming a context for said message, said popup being located, at least in part, proximately to a GUI control or field of most recent user interaction;
allowing at least some GUI interaction to occur while said popup is displayed; and
automatically dismissing said popup when said message has been addressed.

18. The computer readable medium of claim 17 wherein said shape of said popup comprises a two-dimensional body portion with at least one indicator portion extending from said body portion towards said at least one GUI area.

19. The computer readable medium of claim 18 wherein a 1-to-1 correlation exists between said at least one indicator portion and said at least one GUI area.

20. The computer readable medium of claim 18 wherein said at least one indicator portion comprises an arrow.

21. The computer readable medium of any of claims 17 to 20 wherein said popup comprises a modeless window.

22. The computer readable medium of any of claims 17 to 21 wherein said message is an error message.

23. A computing device operable to display a message to a user in a GUI by:
displaying said message in a popup shaped to indicate association with at least one area of the GUI forming a context for said message, said popup being located, at least in part, proximately to a GUI control or field of most recent user interaction;
allowing at least some GUI interaction to occur while said popup is displayed; and
automatically dismissing said popup when said message has been addressed.

24. The computing device of claim 23 wherein said shape of said popup comprises a two-dimensional body portion with at least one indicator portion extending from said body portion towards said at least one GUI area.

25. The computing device of claim 24 wherein a 1-to-1 correlation exists between said at least one indicator portion and said at least one GUI area.

26. The computing device of claim 24 wherein said at least one indicator portion comprises an arrow.

27. The computing device of any of claims 23 to 26 wherein said popup comprises a modeless window.

28. The computing device of any of claims 23 to 27 wherein said message is an error message.
